(19) United States
(12) Patent Application Publication
(10) Pub. No.: US 2019/0332560 A1
(43) Pub. Date: Oct. 31, 2019

(54) INTERFACE CONTROL DEVICE OF COMMUNICATION SYSTEM

(71) Applicant: HONGFUJIN PRECISION ELECTRONICS (CHONGQING) CO., LTD., Chongqing (CN)

(72) Inventor: PIN-HUNG CHEN, New Taipei (TW)

(21) Appl. No.: 16/185,022

(22) Filed: Nov. 9, 2018

(30) Foreign Application Priority Data
Apr. 28, 2018 (CN) 201810403632.0

(51) Int. Cl. G06F 13/362; G06F 13/42

(52) U.S. Cl. CPC G06F 13/362; G06F 2213/0016; G06F 2213/0042; G06F 13/4282

(57) ABSTRACT

An interface control device for controlling communication among a number of USB devices includes a number of USB interfaces, a detection unit, and a USB controller. Each USB interface is configured to couple to one corresponding USB device. The detection unit is electrically coupled to the number of USB interfaces and configured to detect a master-slave relationship of the USB devices. The USB controller is configured to obtain from the detection unit the master-slave relationship of the USB devices and define a type of the USB interfaces coupled to the corresponding USB devices according to the master-slave relationship of the USB devices.

### FIELD

The subject matter herein generally relates to electronic devices, and more particularly to an interface control device for controlling communication between two or more USB devices.

### BACKGROUND

Generally, a master USB device is plugged into an upstream data interface, and a slave USB device is plugged into a downstream data interface to establish communication between the master USB device and the slave USB device.

### BRIEF DESCRIPTION OF THE DRAWINGS

Implementations of the present disclosure will now be described, by way of example only, with reference to the attached figures.

FIG. 1 is a block diagram of a communication system in accordance with an embodiment of the present disclosure.

FIG. 2 is a block diagram of an interface control device and a plurality of USB devices of the communication system in FIG. 1.

FIG. 3 is another block diagram of the interface control device and the plurality of USB devices of the communication system in FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

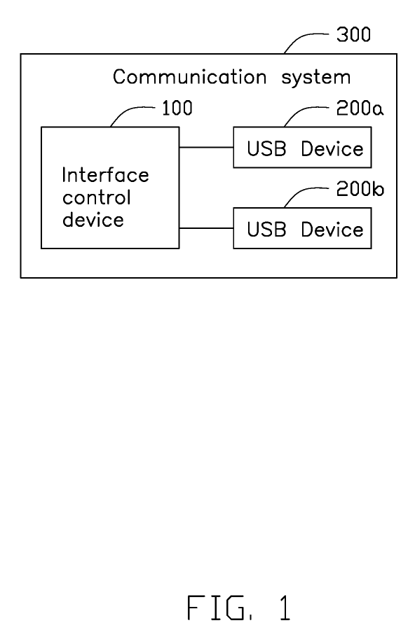

FIG. 1 illustrates an embodiment of a communication system 300 including an interface control device 100 and a plurality of USB devices 200a, 200b. The interface control device 100 is electrically coupled to the plurality of USB devices 200a, 200b to control communication between the USB devices 200a, 200b. In another embodiment, the plurality of USB devices may include more USB devices than the USB devices 200a, 200b.

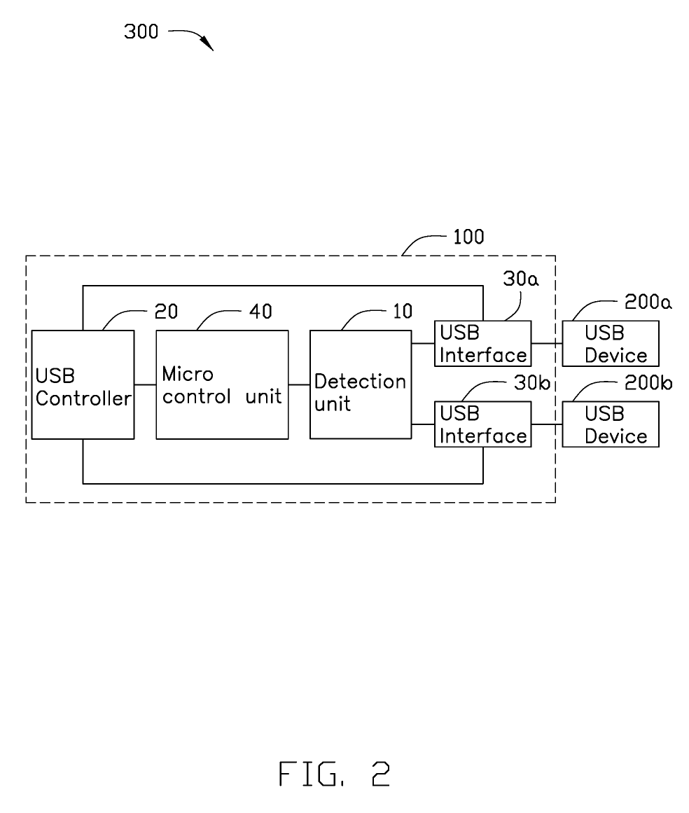

FIG. 2 shows, the interface control device 100 includes a detection unit 10, a USB controller 20, and a plurality of USB interfaces 30a, 30b. In another embodiment, the plurality of USB interfaces may include more USB interfaces than the USB interface 30a, 30b.

The USB interface 30a is electrically coupled to the USB device 200a, and the USB interface 30b is electrically coupled to the USB device 200b.

The detection unit 10 is electrically coupled to the USB devices 200a, 200b.

In detail, when the USB devices 200a, 200b are plugged into the USB interfaces 30a, 30b, the detection unit 10 detects a master-slave relationship between the USB devices 200a, 200b.

The USB controller 20 obtains the master-slave relationship between the USB devices 200a, 200b and defines a type of the USB interfaces 30a, 30b coupled to the corresponding USB devices 200a, 200b according to the master-slave relationship of the USB devices 200a, 200b.

In detail, when the detection unit 10 detects a master USB device of the USB devices 200a, 200b, the USB controller 20 defines a corresponding one of the interfaces 30a, 30b coupled to the master USB device as an upstream data interface.

When the detection unit 10 detects a slave USB device of the USB devices 200a, 200b, the USB controller 20 defines a corresponding one of the interfaces 30a, 30b coupled to the master USB device as a downstream data interface.

In at least one embodiment, the USB interfaces 30a, 30b are both type-C interfaces.

The interface control device 100 further includes a micro control unit 40 electrically coupled between the detection unit 10 and the USB controller 20.

The micro control unit 40 obtains from the detection unit 10 the master-slave relationship between the USB devices 200a, 200b and sends the master-slave relationship between the USB devices 200a, 200b to the USB controller 20. The USB controller 20 defines the type of the USB interface 30a, 30b according to the master-slave relationship between the USB devices 200a, 200b.

In at least one embodiment, the micro control unit 40 establishes communication with the USB controller 20 through an I2C bus.

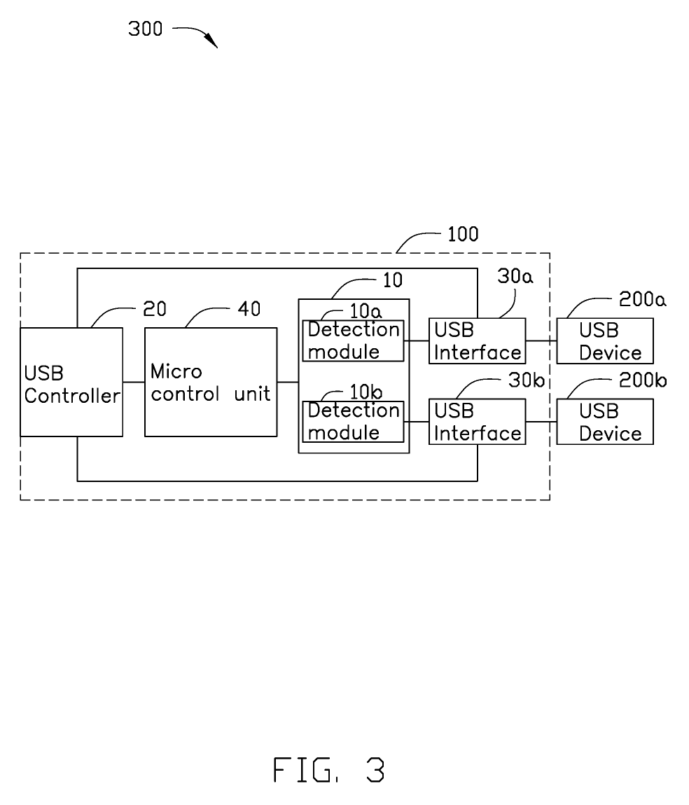

FIG. 3 shows, the detection unit 10 further includes a plurality of detection modules 10a, 10b. A quantity of the detection modules 10a, 10b is equal to a quantity of the USB interfaces 30a, 30b, and each of the detection modules 10a, 10b is electrically coupled to a corresponding one of the USB interfaces 30a, 30b. In another embodiment, a quantity of the detection modules 10a, 10b may be more than two.

When the detection modules 10a, 10b detect the master USB device of the USB devices 200a, 200b, the detection modules 10a, 10b send a detection result of the master USB device to the micro control unit 40. The micro control unit 40 is in communication with the USB controller 20. The USB controller 20 defines the USB interface coupled to the master USB device as the upstream data interface.

When the detection modules 10a, 10b detect the slave USB device of the USB devices 200a, 200b, the detection modules 10a, 10b send a detection result of the slave USB device to the micro control unit 40. The micro control unit 40 is in communication with the USB controller 20. The USB controller 20 defines the USB interface coupled to the slave USB device as the downstream data interface.

Furthermore, the detection modules 10a, 10b determine the master-slave relationship between the USB devices 200a, 200b according to a handshake protocol generated between the detection modules 10a, 10b and the USB devices 200a, 200b.

In detail, when the USB device 200a is electrically coupled to the USB interface 30a, the detection module 10a generates a handshake protocol with the USB device 200a. The detection module 10b determines whether the USB device 200a is the master USB device or the slave USB device according to the handshake protocol.

Correspondingly, when the USB device 200b is electrically coupled to the USB interface 30b, the detection module 10b generates a handshake protocol with the USB device 200b. The detection module 10b determines whether the USB device 200b is the master USB device or the slave USB device according to the handshake protocol.

In use of the interface control device 100, when the USB device 200a is electrically coupled to the USB interface 30a, the detection module 10a generates a handshake protocol with the USB device 200a. The detection module 10a determines that the USB device 200a is the master USB device and sends the detection result of the USB device 200a to the micro control unit 40. The USB controller 20 in communication with the micro control unit 40 obtains the detection result and defines the USB interface 30a as the upstream data interface.

Correspondingly, when the USB device 200b is electrically coupled to the USB interface 30b, the detection module 10b generates a handshake protocol with the USB device 200b. The detection module 10b determines that the USB device 200b is the slave USB device and sends the detection result of the USB device 200b to the micro control unit 40. The USB controller 20 in communication with the micro control unit 40 obtains the detection result and defines the USB interface 30b as the downstream data interface.

In this way, the USB interface 30a is defined as the upstream data interface, the USB interface 30b is defined as the downstream data interface, and the USB device 200a is able to communicate with the USB device 200b through the USB interfaces 30a, 30b.

The USB controller 20 defines the type of interface of the USB interfaces 30a, 30b according to the master-slave relationship between the USB devices 200a, 200b.

When the USB device 200a is the master USB device and the USB device 200b is the slave USB device, the USB controller 20 defines the USB interface 30a as the upstream data interface and defines the USB interface 30b as the downstream data interface.

When the USB device 200b is the master USB device and the USB device 200a is the slave USB device, the USB controller 20 defines the USB interface 30b as the upstream data interface and defines the USB interface 30a as the downstream data interface.

In this way, the USB controller 20 is able to switch the types of the USB interfaces 30a, 30b according to the master-slave relationship between the USB devices 200a, 200b, thereby controlling communication between the USB devices 200a, 200b.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An interface control device for controlling communication among a plurality of USB devices, the interface control device comprising:
a plurality of USB interfaces, each USB interface configured to couple to one corresponding USB device;
a detection unit electrically coupled to the plurality of USB interfaces and configured to detect a master-slave relationship of the USB devices; and
a USB controller configured to obtain from the detection unit the master-slave relationship of the USB devices and define a type of the USB interfaces coupled to the corresponding USB devices according to the master-slave relationship of the USB devices.

2. The interface control device of claim 1, wherein:
when the detection unit detects a master USB device of the USB devices, the USB controller defines the interface coupled to the master USB device as an upstream data interface; and
when the detection unit detects a slave USB device of the USB devices, the USB controller defines the interface coupled to the slave USB device as a downstream data interface.

3. The interface control device of claim 2, further comprising a micro control unit coupled between the detection unit and the USB controller; wherein:
the micro control unit obtains the master-slave relationship of the USB devices from the detection unit and sends the master-slave relationship to the USB controller.

4. The interface control device of claim 3, wherein:
the detection device comprises a plurality of detection modules; and
a quantity of the detection modules is equal to a quantity of the USB interfaces and each detection module is electrically coupled to a corresponding USB interface.

5. The interface control device of claim 4, wherein:
when the detection module detects the master USB device, the detection module sends a detection result of the master USB device to the micro control unit in communication with the USB controller, and the USB controller defines the USB interface coupled to the master USB device as the upstream data interface;
when the detection module detects the slave USB device, the detection module sends a detection result of the slave USB device to the micro control unit in communication with the USB controller, and the USB controller defines the USB interface coupled to the slave USB device as the downstream data interface.

6. The interface control device of claim 5, wherein:
when the USB devices are plugged into the USB interfaces, the detection module generates a handshake protocol with the USB devices; and
the detection module determines the master USB device of the USB devices according to the handshake protocol.

7. The interface control device of claim 3, wherein the micro control unit establishes communication with the USB controller through an I2C bus.

8. The interface control device of claim 1, wherein the USB interface is a type-C USB interface.

9. A communication system comprising:
a plurality of USB devices; and
an interface control device configured to control communication among the plurality of USB devices, the interface control device comprising:
a plurality of USB interfaces, each USB interface configured to couple to one corresponding USB device;
a detection unit electrically coupled to the plurality of USB interfaces and configured to detect a master-slave relationship of the USB devices; and
a USB controller configured to obtain from the detection unit the master-slave relationship of the USB devices and define a type of the USB interfaces coupled to the corresponding USB devices according to the master-slave relationship of the USB devices.

10. The communication system of claim 9, wherein:
when the detection unit detects a master USB device of the USB devices, the USB controller defines the interface coupled to the master USB device as an upstream data interface; and
when the detection unit detects a slave USB device of the USB devices, the USB controller defines the interface coupled to the slave USB device as a downstream data interface.

11. The communication system of claim 10, wherein:
the interface control device further comprises a micro control unit coupled between the detection unit and the USB controller; and
the micro control unit obtains the master-slave relationship of the USB devices from the detection unit and sends the master-slave relationship to the USB controller.

12. The communication system of claim 11, wherein:
the detection device comprises a plurality of detection modules; and
a quantity of the detection modules is equal to a quantity of the USB interfaces and each of the detection modules is electrically coupled to a corresponding one of the USB interfaces.

13. The communication system of claim 12, wherein:
when the detection module detects the master USB device, the detection module sends a detection result of the master USB device to the micro control unit in communication with the USB controller, and the USB controller defines the USB interface coupled to the master USB device as the upstream data interface;
when the detection module detects the slave USB device, the detection module sends a detection result of the slave USB device to the micro control unit in communication with the USB controller, and the USB controller defines the USB interface coupled to the slave USB device as the downstream data interface.

14. The communication system of claim 13, wherein:
when the USB devices are plugged into the USB interfaces, the detection module generates a handshake protocol with the USB devices; and
the detection module determines the master USB device of the USB devices according to the handshake protocol.

15. The communication system of claim 11, wherein the micro control unit establishes communication with the USB controller through an I2C bus.

16. The communication system of claim 9, wherein the USB interface is a type-C USB interface.
